(19) United States
(12) Patent Application Publication
(10) Pub. No.: US 2025/0105498 A1
(43) Pub. Date: Mar. 27, 2025

(54) ANTENNA DEVICE AND IC CARD

(71) Applicant: TDK Corporation, Tokyo (JP)

(72) Inventors: Shoma KAJIKIYA, Chuo-ku (JP); Tomoyuki GOI, Chuo-ku (JP)

(73) Assignee: TDK Corporation, Tokyo (JP)

(21) Appl. No.: 18/887,078

(22) Filed: Sep. 17, 2024

(30) Foreign Application Priority Data
Sep. 22, 2023 (JP) 2023-158044

(51) Int. Cl. H01Q 1/38; H01Q 1/22

(52) U.S. Cl. CPC H01Q 1/38; H01Q 1/2283

(57) ABSTRACT

An antenna device is an antenna device including a mesh-shaped conductor pattern having a plurality of mesh portions, in which the conductor pattern includes a plurality of first electroconductive lines extending in a first direction and a plurality of second electroconductive lines extending in a second direction intersecting the first direction, an opening and a slit extending from the opening to an edge of the conductor pattern are formed in the conductor pattern as a region where the first electroconductive lines and the second electroconductive lines are not formed, a width of the slit is smaller than a width of the opening, and at least a part of the mesh portions arranged at an edge of the slit is opened to the slit.

### CROSS-REFERENCE TO RELATED APPLICATION

This application claims priority to Japanese Patent Application No. 2023-158044 filed on Sep. 22, 2023, the entire contents of which are incorporated by reference herein.

### TECHNICAL FIELD

The present disclosure relates to an antenna device and an IC card.

### BACKGROUND

Conventionally, an antenna device including a mesh-shaped conductor pattern is known (for example, Japanese Unexamined Patent Publication No. 2014-7655). In this antenna device, a notch is formed at a position where the IC chip is disposed.

### SUMMARY

An antenna device according to one aspect of the present disclosure is an antenna device including a mesh-shaped conductor pattern having a plurality of mesh portions, in which the conductor pattern includes a plurality of first electroconductive lines extending in a first direction and a plurality of second electroconductive lines extending in a second direction intersecting the first direction, an opening and a slit extending from the opening to an edge of the conductor pattern are formed in the conductor pattern as a region where the first electroconductive lines and the second electroconductive lines are not formed, a width of the slit is smaller than a width of the opening, and at least a part of the mesh portions arranged at an edge of the slit is opened to the slit.

An IC card according to one aspect of the present disclosure includes the above-described antenna device and an IC module disposed in the opening.

### BRIEF DESCRIPTION OF THE DRAWINGS

FIG. 1 is a schematic perspective view illustrating an appearance of an IC card incorporating an antenna device according to an embodiment of the present disclosure;

FIG. 2 is an exploded perspective view of the IC card as viewed from a lower surface side;

FIG. 3 is a cross-sectional view taken along line III-III illustrated in FIG. 1;

FIG. 4 is a plan view of the antenna device;

FIG. 5 is an enlarged view of the vicinity of a connection portion between a slit and an opening;

FIG. 6 is an enlarged view illustrating a conductor pattern of an antenna device according to a comparative example;

FIG. 7 is a plan view of an antenna device according to a modification;

FIGS. 8A and 8B are cross-sectional views of an antenna device according to a modification;

FIGS. 9A to 9C are cross-sectional views of an antenna device according to a modification; and

FIGS. 10A and 10B are cross-sectional views of an antenna device according to a modification.

### DETAILED DESCRIPTION

Here, in the antenna device as described above, an electroconductive line extending along the edge is formed at an edge of the notched portion. In this case, due to the influence of the electroconductive line along the edge, the pitch of the mesh is narrowed, and thus there is a problem that the conductor pattern in the notched portion is easily visually recognized.

Accordingly, an object of the present disclosure is to provide an antenna device and an IC card capable of suppressing visibility.

According to one aspect of the present disclosure, it is possible to provide an antenna device and an IC card capable of suppressing visibility.

Hereinafter, some embodiments of the present disclosure will be described in detail. However, the present disclosure is not limited to the following embodiments.

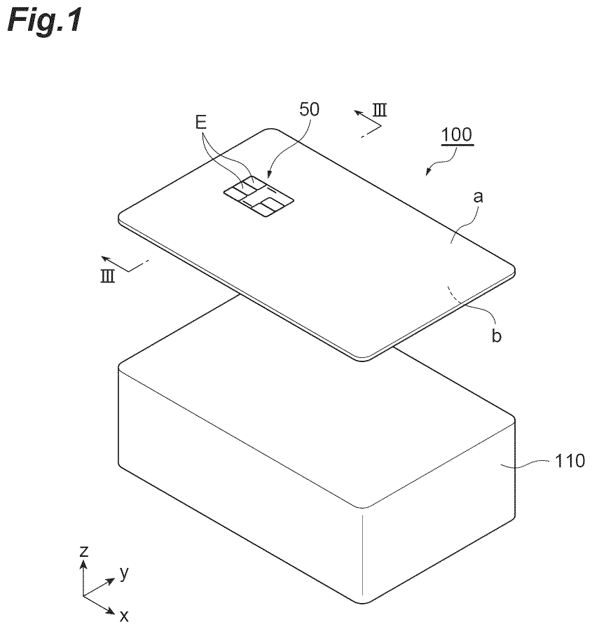

FIG. 1 is a schematic perspective view illustrating an appearance of an IC card 100 incorporating an antenna device according to an embodiment of the present disclosure. The IC card 100 illustrated in FIG. 1 is a plate-like body in which a y-axis direction is a lateral direction, an x-axis direction is a longitudinal direction, and a z-axis direction is a thickness direction, and has an upper surface a and a lower surface b constituting an xy surface. The IC card 100 incorporates an IC module 50 and an antenna device to be described later, and a terminal electrode E of the IC module is exposed on the upper surface a of the IC card 100. The IC card 100 can perform communication via the antenna device by making the lower surface b face the card reader 110.

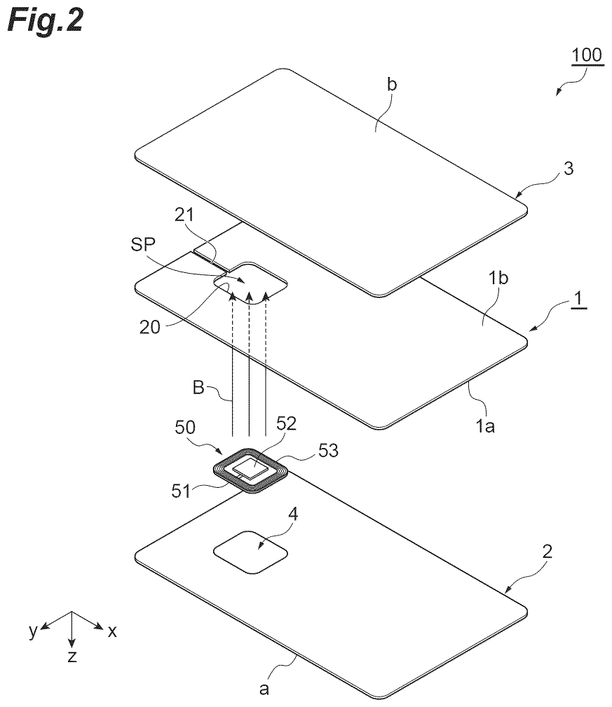

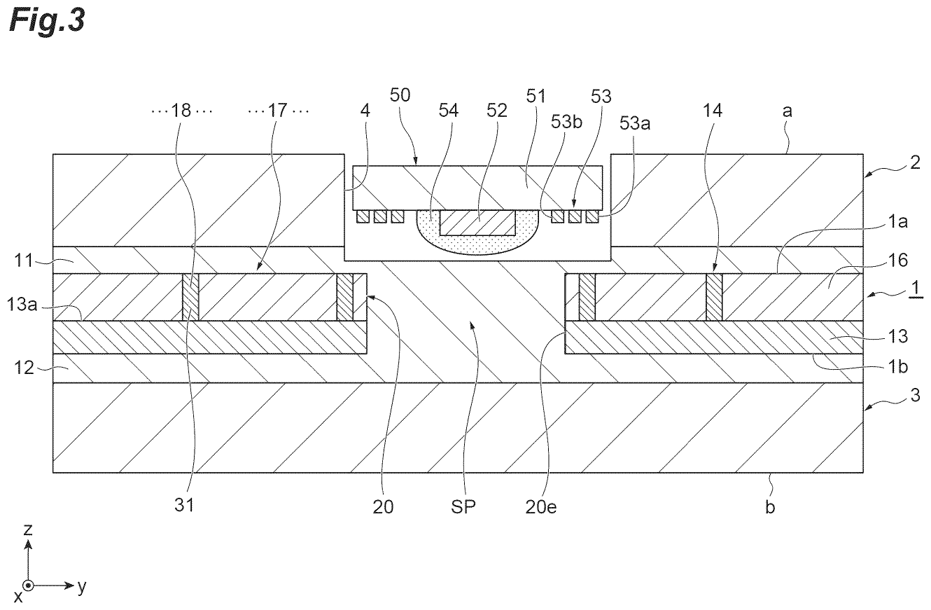

FIG. 2 is an exploded perspective view of the IC card 100 as viewed from the lower surface b side. FIG. 3 is a cross-sectional view taken along line III-III illustrated in FIG. 1. FIG. 3 illustrates a structure near the IC module 50. As illustrated in FIGS. 2 and 3, the IC card 100 has a structure in which a cover layer 2, an antenna device 1, and a cover layer 3 are stacked in this order from the upper surface a side toward the lower surface b side. In addition, the IC card 100 includes the IC module 50. Note that, in the present embodiment, the IC module 50 is disposed in a region of the IC card 100 on the negative side in the X-axis direction and at a position closer to the positive side in the Y-axis direction. However, the position of the IC module 50 is not particularly limited.

The cover layer 2 is a plate-shaped member that covers a main surface 1a on the positive side in the z-axis direction of the antenna device 1. The surface of the cover layer 2 on the positive side in the z-axis direction constitutes the upper surface a of the IC card 100. The cover layer 2 is provided with a substantially rectangular opening 4. The opening 4 penetrates the cover layer 2 in the thickness direction (Z-axis direction). The IC module 50 is disposed inside the opening 4 (see FIG. 3). The cover layer 3 is a plate-shaped member that covers a main surface 1b on the negative side in the z-axis direction of the antenna device 1. The surface of the cover layer 3 on the negative side in the z-axis direction constitutes the lower surface b of the IC card 100. The cover layer 2 is bonded to the antenna device 1 via an adhesive layer 11. The surface of the cover layer 3 on the negative side in the z-axis direction constitutes the lower surface b of the IC card 100. The cover layer 3 is bonded to the antenna device 1 via the adhesive layer 12.

The cover layers 2 and 3 may be transparent resin substrates. The cover layers 2 and 3 may be formed by, for example, cellulose propionate (CP), polyvinyl chloride (PVD), polycarbonate (PC), tempered glass, or the like. The thickness of the cover layers 2 and 3 is not particularly limited, but may be 200 to 400 μm. The total light transmittance of the cover layers 2 and 3 may be 90 to 100%.

The adhesive layers 11 and 12 are layers formed by filling an adhesive. As a material of the adhesive layers 11 and 12, an acrylic adhesive, a urethane-based adhesive, or the like may be employed. The adhesive layers 11 and 12 may have no base material, high total light transmittance, and low haze. The thicknesses of the adhesive layers 11 and 12 are not particularly limited, but may be 10 to 100 μm. The total light transmittance of the adhesive layers 11 and 12 may be 90 to 100%.

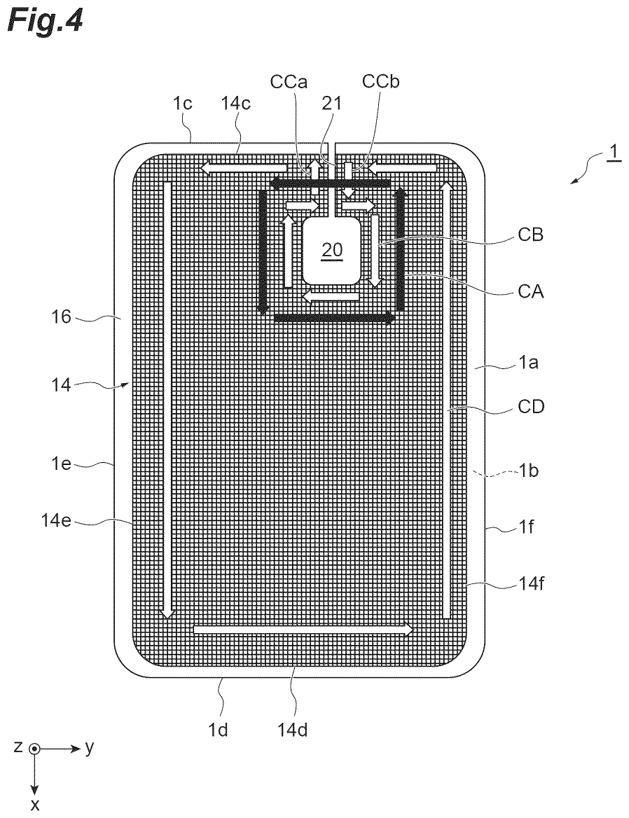

FIG. 4 is a plan view of the antenna device 1. As illustrated in FIG. 4, the antenna device 1 is a rectangular plate-like member. The antenna device 1 includes a negative-side edge 1c in the x-axis direction, a positive-side edge 1d in the x-axis direction, a negative-side edge 1e in the y-axis direction, and a positive-side edge 1f in the y-axis direction. In the present embodiment, the edges 1c and 1d are short sides, and the edges 1e and 1f are long sides.

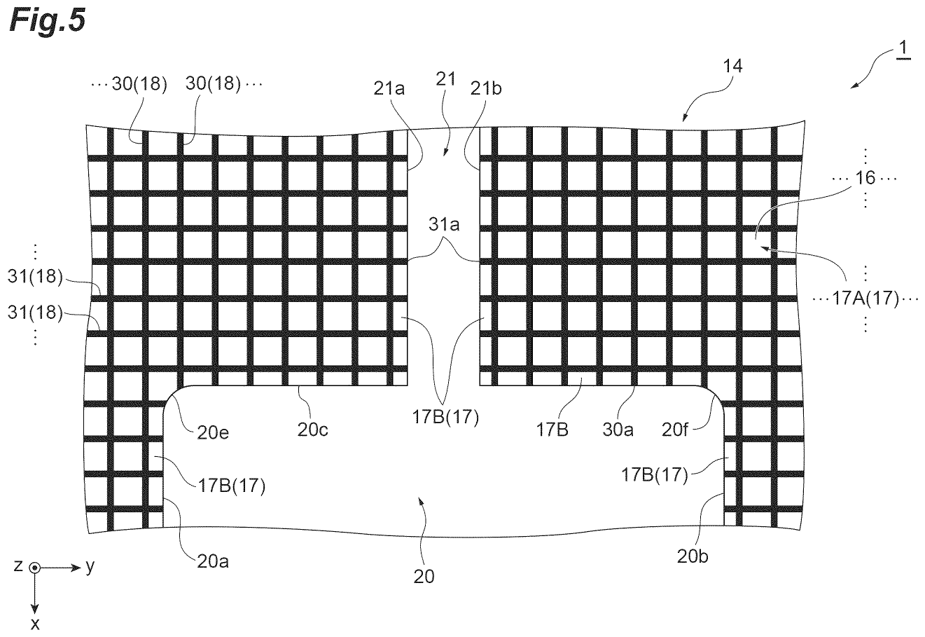

The antenna device 1 includes a mesh-shaped conductor pattern 14 having a plurality of mesh portions 17 (see FIGS. 3 and 5). The conductor pattern 14 is a mesh-like pattern including a plurality of regularly arranged mesh portions 17 (see FIGS. 3 and 5) formed by a plurality of electroconductive lines intersecting each other. Note that details of the configuration of the pattern of the conductor pattern 14 will be described later. The conductor pattern 14 is formed on substantially the entire surface of the main surface 1a of the antenna device 1. The conductor pattern 14 has a rectangular shape corresponding to the shape of the main surface 1a. The conductor pattern 14 includes an edge 14c on the negative side in the x-axis direction, an edge 14d on the positive side in the x-axis direction, an edge 14e on the negative side in the y-axis direction, and an edge 14f on the positive side in the y-axis direction. The edges 14c, 14d, 14e, and 14f extend in parallel along the edges 1c, 1d, 1e, and 1f, and are disposed on an inner peripheral side from the edges 1c, 1d, 1e, and 1f. However, the edges 14c, 14d, 14e, and 14f may be arranged without gaps from the edges 1c, 1d, 1e, and 1f. In addition, the shape and size of the conductor pattern 14 are not particularly limited as long as the conductor pattern can function as an antenna.

In the conductor pattern 14, an opening 20 and a slit 21 extending from the opening 20 to an edge 14c of the conductor pattern 14 are formed as a region where electroconductive lines (first electroconductive lines and second electroconductive lines to be described later) are not formed. The opening 20 is formed at a position where the IC module 50 is disposed. The opening 20 has a rectangular shape corresponding to the shape of the IC module 50. The slit 21 extends from the side on the negative side in the x-axis direction of the opening 20 to the edge 14c on the negative side in the x-axis direction of the conductor pattern 14. The slit 21 extends parallel to the x-axis direction with a constant width. Note that the width of the slit 21 and the width of the opening 20 are dimensions in a direction orthogonal to an extending direction and the penetrating direction of the slit 21, that is, a distance between edges extending along the extending direction of the slit 21. A width (dimension in the y-axis direction) of slit 21 is smaller than a width (dimension in the y-axis direction) of the opening 20. The opening 20 and the slit 21 are configured as penetrating portions penetrating the antenna device 1 from the main surface 1a to the main surface 1b. The slit 21 extends from the opening 20 to the edge 1c, and the end in the x direction of the slit 21 is opened to an outer peripheral side at the edge 1c.

As illustrated in FIG. 3, the antenna device 1 includes a base material 13, a conductor pattern 14 provided on one first main surface 13a of the base material 13, and a resin layer 16 provided on the first main surface 13a of the base material 13. The conductor pattern 14 extends in a direction along the first main surface 13a of the base material 13 and has a plurality of mesh portions 17. The conductor pattern 14 has conductor portions 18 forming the mesh portions 17. The resin layer 16 is disposed between a plurality of conductor portions 18, that is, in the mesh portions 17. In FIG. 3, the conductor portions 18 are illustrated in a deformed state, and the width and pitch of the conductor portions 18 are adjusted.

The base material 13 has light transmissivity to an extent required as the antenna device 1. Specifically, the total light transmittance of the base material 13 may be 90 to 100%. The haze of the base material 13 may be 0 to 5%.

The base material 13 may be, for example, a transparent resin film, and examples thereof include a film of polyethylene terephthalate (PET), polycarbonate (PC), polyethylene naphthalate (PEN), cycloolefin polymer (COP), or polyimide (PI). Alternatively, the base material 13 may be a glass substrate.

The thickness of the base material 13 may be equal to or more than 10 μm, equal to or more than 20 μm, or equal to or more than 35 μm, and may be equal to or less than 500 μm, equal to or less than 200 μm, or equal to or less than 100 μm.

The conductor portion 18 may contain metal. The conductor portion 18 may contain at least one metal selected from copper, nickel, cobalt, palladium, silver, gold, platinum, and tin, or may contain copper. The conductor portion 18 may be metal plating formed by a plating method. The conductor portion 18 may further contain a nonmetallic element such as phosphorus within a range in which appropriate conductivity is maintained.

The resin layer 16 is formed by a light-transmissive resin and is provided so as to fill the mesh portions 17, and a flat surface is usually formed by the resin layer 16 and the conductor portion 18.

The resin layer 16 is formed by a light-transmissive resin. The total light transmittance of the resin layer 16 may be 90 to 100%. The resin layer 16 may have a haze of 0 to 5%.

The resin that forms the resin layer 16 may be a cured product of a curable resin composition (photocurable resin composition or thermosetting resin composition). The curable resin composition forming the resin layer 16 includes a curable resin, and examples thereof include an acrylic resin, an amino resin, a cyanate resin, an isocyanate resin, a polyimide resin, an epoxy resin, an oxetane resin, a polyester, an allyl resin, a phenolic resin, a benzoxazine resin, a xylene resin, a ketone resin, a furan resin, a COPNA resin, a silicon resin, a dicyclopentadiene resin, a benzocyclobutene resin, an episulfide resin, a thiol-ene resin, a polyazomethine resin, a polyvinyl benzyl ether compound, acenaphthylene, and an ultraviolet curable resin containing a functional group that causes a polymerization reaction with ultraviolet rays such as an unsaturated double bond, a cyclic ether, and a vinyl ether.

In the opening 20 and the slit 21 (see FIG. 4), a through hole penetrating the resin layer 16 and the base material 13 in the z-axis direction is formed. Therefore, the opening 20 and the slit 21 (see FIG. 4) are regions where the resin layer 16, the base material 13, and the conductor pattern 14 do not exist. In the antenna device 1 before being assembled as the IC card 100, a space SP is provided in the opening 20 and the slit 21 (see FIG. 2). In the antenna device 1 assembled as the IC card 100, the space SP of the opening 20 is filled with the adhesive of the adhesive layers 11 and 12.

The IC module 50 includes a module substrate and an IC chip 52 mounted on or incorporated in the module substrate 51, and a coupling coil 53 is formed on a negative surface of the module substrate 51 in the z-axis direction (see also FIG. 2). The terminal electrode E illustrated in FIG. 1 is provided on the front surface side of the module substrate 51. The IC chip 52 may be covered with a resin 54.

The IC module 50 is disposed in the opening 4 of the cover layer 2. An inner peripheral surface of the opening 4 is disposed so as to surround the IC module 50 from the outer peripheral side. The IC module 50 is disposed to face the opening 20 of the antenna device 1 at a position on the positive side in the z-axis direction. The sizes of the opening 20 in the y-axis direction and the x-axis direction are smaller than those of the IC module 50. Further, the sizes of the opening 20 in the y-axis direction and the x-axis direction are smaller than an edge 53a on an outer peripheral side of the coupling coil 53 and larger than an edge 53b on an inner peripheral side of the coupling coil 53. Thus, when viewed from the z-axis direction, four inner peripheral surfaces 20e of the opening 20 are disposed so as to overlap four side portions of the coupling coil 53.

Next, functions of the antenna device 1 will be described with reference to FIG. 4. A current CA flows through the coupling coil 53 (see FIG. 2) of the IC module 50. In FIG. 4, it is assumed that the current CA flows counterclockwise. At this time, a magnetic flux B (see FIG. 2) of coupling coil 53 acts on the edge of opening 20. Thus, a clockwise eddy current CB flows through the conductor pattern 14 near the edge of the opening 20. As described above, the conductor pattern 14 near the edge of the opening 20 functions as a coupling coil that is magnetically coupled to the coupling coil 53 of the IC module 50. Here, the conductor pattern 14 at the edge of the opening 20 on the negative side in the x-axis direction is divided by the slit 21 up to the edge 14c. Thus, the eddy current CB is divided by the slit 21, and currents CCa and CCb in the x-axis direction along the slit 21 flow. The current CCa flowing from the opening 20 toward the edge 14c side flows through the conductor pattern 14 at the edge of the slit 21 on the negative side in the y-axis direction. Thus, the counterclockwise current CD flows through the entire conductor pattern 14. In the conductor pattern 14 at the edge of the slit 21 on the positive side in the y-axis direction, the current CCb that returns from the edge 14c side to the opening 20 flows. As described above, the current in the same direction as the IC module 50 flows through the entire conductor pattern 14 of the antenna device 1, whereby the antenna device 1 can function as an antenna.

Next, the conductor pattern 14 will be described in detail with reference to FIG. 5. FIG. 5 is an enlarged view in which the vicinity of a connection portion between the slit 21 and the opening 20 is enlarged. FIG. 5 illustrates an edge 21a on the negative side in the y-axis direction and an edge 21b on the positive side in the y-axis direction of slit 21. Further, an edge 20a on the negative side in the y-axis direction, an edge 20b on the positive side in the y-axis direction, and an edge 20c on the negative side in the x-axis direction of the opening 20 are illustrated. The edges 20a, 20b, 21a, and 21b extend parallel to the x-axis direction. The edge 20c extends parallel to the y-axis direction.

As illustrated in FIG. 5, the conductor pattern 14 includes a plurality of first electroconductive lines 30 and a plurality of second electroconductive lines 31. The first electroconductive lines 30 are linear conductor portions 18 extending parallel to the x-axis direction (first direction). The plurality of first electroconductive lines 30 is arranged to be spaced apart from each other in the y-axis direction. The plurality of first electroconductive lines 30 is arranged to be spaced apart at a constant pitch. The second electroconductive lines 31 are linear conductor portions 18 extending parallel to the y-axis direction (second direction). The plurality of second electroconductive lines 31 is arranged to be spaced apart from each other in the x-axis direction. The plurality of second electroconductive lines 31 is arranged to be spaced apart at a constant pitch. The line width of the electroconductive lines 30 and 31 is not particularly limited, and may be set to, for example, 1 to 3 μm. The pitch of the electroconductive lines 30 and 31 is not particularly limited, and may be set to, for example, 50 to 200 μm. The first electroconductive lines 30 and the second electroconductive lines 31 have a line thickness larger than a line width. The line thickness of the electroconductive lines 30 and 31 are dimensions in the z-axis direction. Thus, the cross-sectional shapes of the electroconductive lines 30 and 31 have shapes extending in the z-axis direction (see FIG. 3). The line thickness of the electroconductive lines 30 and 31 is not particularly limited, and may be set to, for example, 2 to 5 μm. Note that the ends of the electroconductive lines 30 and 31 in the z-axis direction may or may not coincide with the surface of the resin layer 16 in the z-axis direction.

In the present embodiment, the first electroconductive lines 30 are substantially parallel to the x-axis direction which is the extending direction of the slit 21. The other second electroconductive lines 31 are substantially orthogonal to the x-axis direction which is the extending direction. Note that the first electroconductive lines 30 need not be parallel to the x-axis direction as long as they extend in the x-axis direction, and the second electroconductive lines 31 need not be parallel to the y-axis direction as long as they extend in the y-axis direction.

The normal mesh portions 17 other than the vicinity of the slit 21 and the vicinity of the opening 20 will be described. Each mesh portion 17 includes a pair of first electroconductive lines 30 adjacent to each other and a pair of second electroconductive lines 31 adjacent to each other. Such a mesh portion 17 may be usually referred to as a mesh portion 17A. In the present embodiment, each mesh portion 17 has a square shape. However, when the pitch of the first electroconductive lines 30 and the pitch of the second electroconductive lines 31 are different from each other, the mesh portions 17 have a rectangular shape. In the mesh portions 17, the resin layer 16 (FIG. 3) is disposed in an internal space surrounded by the four electroconductive lines 30 and 31. The pitch of the mesh portions 17 in the y-axis direction is equal to the pitch of the first electroconductive lines 30. The pitch of the mesh portions 17 in the x-axis direction is equal to the pitch of the second electroconductive lines 31. The width (dimension in the y-axis direction) of the slit 21 may be larger than the pitch in the y-axis direction of the mesh portions 17. The width of the slit 21 may be larger than the pitch of the mesh portions 17 in the x-axis direction. Note that, in the mesh portions 17, the first electroconductive lines 30 and the second electroconductive lines 31 only need to intersect each other, and do not necessarily need to be orthogonal to each other. That is, the mesh portions 17 in which the first electroconductive lines 30 and the second electroconductive lines 31 intersect in an inclined state may be employed.

The mesh portions 17 arranged at the edges 21a and 21b of the slit 21 is opened to the slit 21. Note that such a mesh portion 17 may be referred to as an open mesh portion 17B. Electroconductive lines extending in the x-axis direction along the edges 21a and 21b are not formed at the edges 21a and 21b of the slit 21. In the edges 21a and 21b, ends 31a of the second electroconductive lines 31 in the y-axis direction exist in an independent state. Of the edges 21a and 21b, the resin layer 16 exists between the ends 31a of the second electroconductive lines 31 and the end 31a of the adjacent second electroconductive lines 31. With such a configuration, open mesh portions 17B arranged at the edge 21a do not have the first electroconductive lines 30 extending in the x-axis direction on the positive side in the y-axis direction. Thus, the open mesh portions 17B arranged at the edge 21a have a structure surrounded by the electroconductive lines on the negative side in the y-axis direction and on both sides in the x-axis direction, and opened to the slit 21 on the positive side in the y-axis direction. The open mesh portions 17B arranged at the edge 21b do not have the first electroconductive lines 30 extending in the x-axis direction on the negative side in the y-axis direction. Accordingly, the open mesh portions 17B arranged at the edge 21b have a structure surrounded by the electroconductive lines on the positive side in the y-axis direction and on both sides in the x-axis direction, and opened to the slit 21 on the negative side in the y-axis direction. However, the above relationship does not need to be established over the entire areas of the edges 21a and 21b of the slit 21. For example, a part of the slit 21 may be hidden by the IC module 50. In this case, the portions hidden by the IC module 50 in the edges 21a and 21b of the slit 21 may not be opened to the slit 21. A region hidden by the IC module 50 in the slit 21 is near the end of the slit 21 connected to the opening 20. It is preferable that the edges 21a and 21b of the slit 21 are open in a region other than the region hidden by the IC module 50. Thus, when the total lengths of the edges 21a and 21b are 100%, the open region is preferably 80% or more.

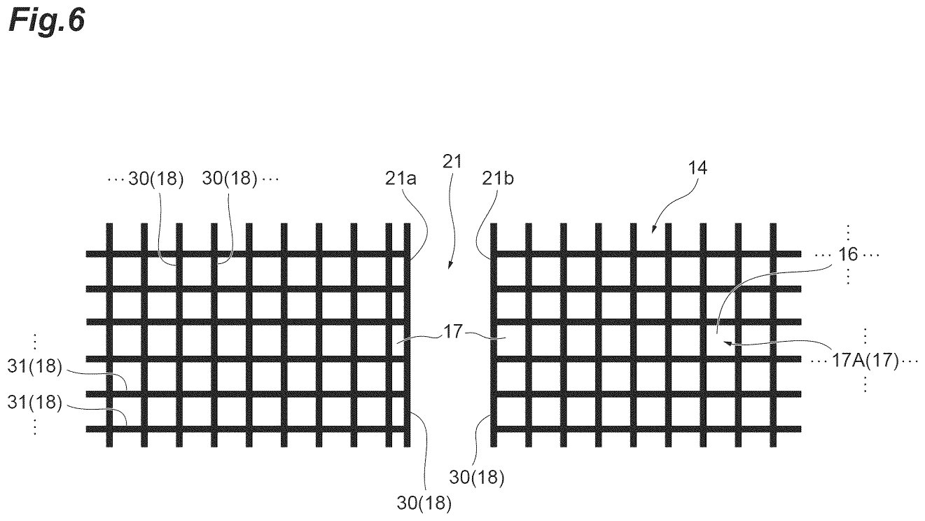

Note that, in the conductor pattern 14 illustrated in FIG. 6, the first electroconductive lines 30 extend along the edges 21a and 21b of the slit 21. In such a structure, the mesh portions 17 arranged at the edge 21a and the mesh portions 17 arranged at the edge 21b are surrounded by the electroconductive lines in all directions, and are closed by the first electroconductive lines 30 on the edges 21a and 21b with respect to the slit 21. Such mesh portions 17 do not correspond to the mesh portions 17 opened to the slit 21. However, in the example illustrated in FIG. 5, both of the edges 21a and 21b of the slit 21 are opened to the slit 21. However, it is sufficient if at least one of the edges 21a and 21b is opened. That is, due to a design relationship, on the other of the edges 21a and 21b, the first electroconductive lines 30 may be accidentally disposed at the position of the edge 21b, as the edge 21b illustrated in FIG. 6.

The mesh portions 17 arranged at the edges 20a, 20b, and 20c of the opening 20 are opened to the opening 20. The open mesh portions 17B arranged at the edges 20a and 20b of the opening 20 are open to the opening 20 in the same manner as the open mesh portions 17B arranged at the edges 21a and 21b of the slit 21. Electroconductive lines extending in the y-axis direction along the edge 20c are not formed at the edge 21c of the opening 20. In the edge 20c, ends 30a of the first electroconductive lines 30 in the x-axis direction exist in an independent state. In the edge 20c, the resin layer 16 exists between the ends 30a of the first electroconductive lines 30 and the ends 30a of the adjacent first electroconductive lines 30. With such a configuration, the open mesh portions 17B arranged at the edge 20c do not have the second electroconductive lines 31 extending in the y-axis direction on the positive side in the x-axis direction. Thus, the open mesh portions 17B arranged at the edge 20c have a structure surrounded by the electroconductive lines on the negative side in the x-axis direction and on both sides in the y-axis direction, and opened to the opening 20 on the positive side in the x-axis direction. Note that the open mesh portions 17B disposed at the edge of the opening 20 on the positive side in the x-axis direction, which is not illustrated, is open to the opening 20 on the negative side in the x-axis direction.

Next, functions and effects of the antenna device 1 and the IC card 100 according to the present embodiment will be described.

In the antenna device 1, in the conductor pattern 14, the opening 20 and the slit 21 extending from the opening 20 to the edge 14c of the conductor pattern 14 are formed as regions where first electroconductive lines 30 and second electroconductive lines 31 are not formed. The width of the slit 21 is smaller than the width of the opening 20. When the first electroconductive lines 30 are provided along the edge 21a of the slit 21 as illustrated in FIG. 6 with respect to the slit 21, the mesh portions 17 having a pitch narrower than that of the normal mesh portions 17A are formed. In this case, the visibility in the vicinity of the edge 21a of the slit 21 increases.

On the other hand, as illustrated in FIG. 5, in the antenna device 1 according to the present embodiment, at least a part of the open mesh portions 17B arranged at the edges 21a and 21b of the slit 21 is open to the slit 21. In this case, the formation of the mesh portions 17 having a narrow pitch can be suppressed. Thus, visibility of the antenna device 1 can be suppressed.

The mesh portions 17 disposed at the edge of the opening 20 may be opened with respect to the opening 20. In this case, it is possible to suppress formation of the mesh portions 17 with a narrow pitch at the edge of the opening 20. Thus, visibility in the vicinity of the opening 20 can be suppressed.

The first electroconductive lines 30 and the second electroconductive lines 31 may have a line thickness larger than a line width. Thus, electroconductive lines having a high aspect ratio can be formed, and resistance can be reduced while visibility in plan view is suppressed.

A resin (resin layer 16) may be provided in the mesh portions 17, and a space SP may be formed in the opening 20. By providing the resin layer 16 in the mesh portions 17, the shape of the conductor pattern 14 can be maintained and the flatness can be secured. In addition, since the resin layer 16 is not provided in the opening 20, interference with the IC module 50 can be suppressed.

One of the first electroconductive lines 30 and the second electroconductive lines 31 may be substantially parallel to the extending direction of the slit 21, and the other may be substantially orthogonal to the extending direction. In this case, communication characteristics as the antenna device 1 can be improved.

The width of the slit 21 may be larger than the pitch of the mesh portions 17. In this case, it is possible to obtain an effect of suppressing short-circuiting of the mesh portions 17 arranged at the edges on both sides of the slit 21 due to a manufacturing error or the like.

The IC card 100 according to one aspect of the present disclosure includes the antenna device 1 described above and the IC module 50 arranged in the opening 20.

With the IC card 100, effects similar to those of the antenna device 1 described above can be obtained.

The present disclosure is not limited to the above-described embodiment.

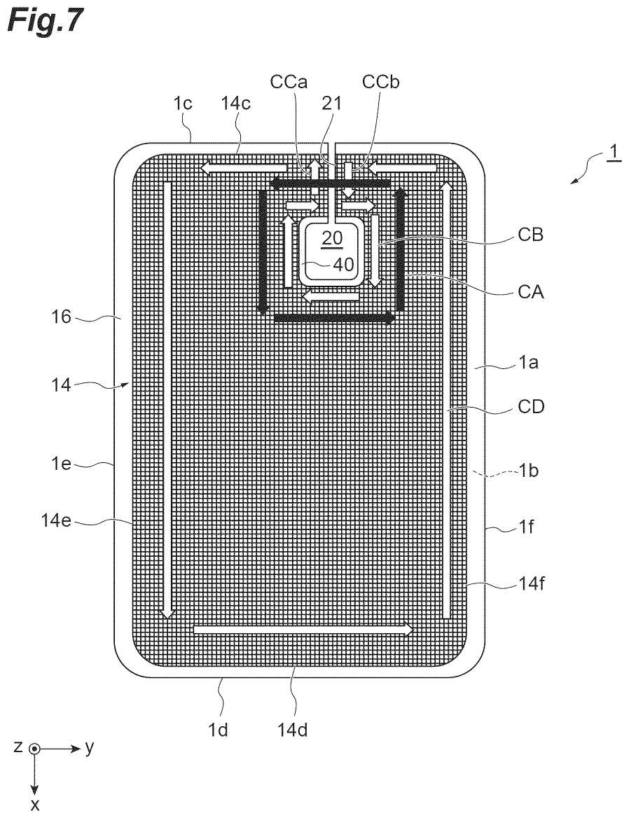

For example, as illustrated in FIG. 7, conductor portions 40 having a wider line width than the first electroconductive lines 30 and the second electroconductive lines 31 may be disposed along the edge of the opening 20. The conductor portion 40 has a rectangular annular shape by extending along the four edges of the opening 20. The conductor portion 40 may be configured by electroconductive lines having a wide line width, or may be configured by a mesh pattern having a pitch narrower than that of the normal mesh portions 17A. As illustrated in FIG. 3, the edge of the opening 20 is a portion hidden by overlapping with the coupling coil 53 of the IC module 50. Therefore, since there is a case where the visibility is not affected, the resistance can be reduced by disposing the thick conductor portion 40 at this position. Note that, in a case where suppression of visibility in the vicinity of the edge of the opening 20 is required, it is only necessary to employ the configuration illustrated in FIG. 5.

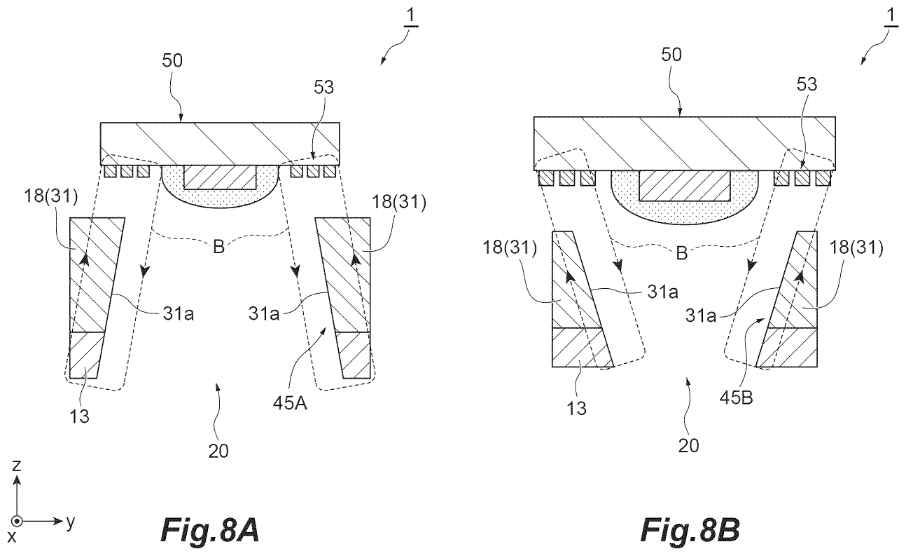

A configuration illustrated in FIGS. 8A and 8B may be employed. That is, the pair of ends 30a (see FIG. 5, first end) of the first electroconductive lines 30 facing each other in the x-axis direction through the opening 20 and the pair of ends 31a (second ends) of the second electroconductive lines 31 facing each other in the y-axis direction through the opening 20 may have tapered shapes 45A and 45B expanding from one side to another side in the z-axis direction (thickness direction). The tapered shape 45A illustrated in FIG. 8A spreads from the positive side to the negative side in the z-axis direction. The tapered shape 45B illustrated in FIG. 8B spreads from the negative side to the positive side in the z-axis direction. As illustrated in FIGS. 8A and 8B, the distribution mode of the magnetic flux generated between the coupling coil 53 of the IC module 50 and the edge of the opening 20 changes depending on the inclination direction and the magnitude of the angle of the tapered shape 45B. Therefore, by employing the tapered shapes 45A and 45B, the magnetic coupling between the coupling coil 53 and the edge of the opening 20 can be adjusted.

In the above-described embodiment, the structure in which the conductor pattern 14 is provided only on one main surface of the base material 13 has been exemplified. However, the structure of the antenna device 1 is not limited to this structure.

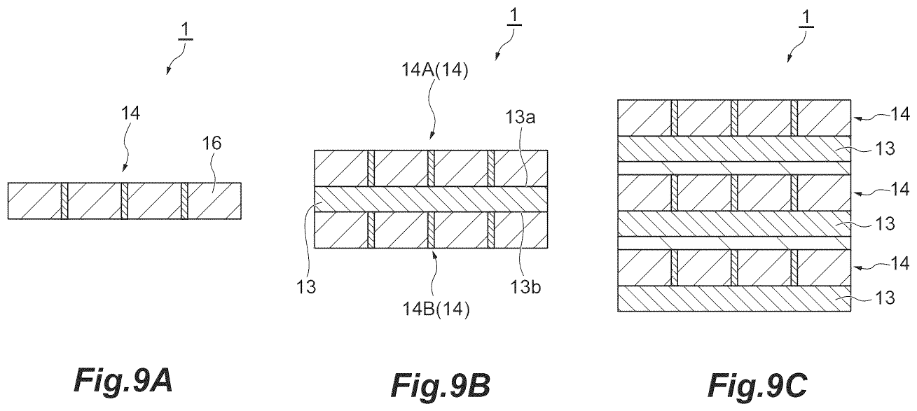

For example, as illustrated in FIG. 9A, the base material 13 may be omitted. In this case, the conductor pattern 14 is supported only by the resin layer 16.

In addition, as illustrated in FIG. 9B, the conductor pattern 14 may include a first mesh pattern 14A provided on a first main surface 13a of the base material 13 and a second mesh pattern 14B provided on a second main surface 13b of the base material 13. When viewed from the thickness direction of the base material 13, at least a part of the electroconductive lines of the first mesh pattern 14A may overlap the electroconductive lines of the second mesh pattern 14B. In this case, since the two mesh patterns 14A and 14B can be stacked on one base material 13, the number of base materials 13 at the time of stacking can be reduced, the cost can be reduced, and the thickness can be reduced. Further, by overlapping the mesh patterns 14A and 14B, moiré can be suppressed, and communication characteristics can be improved by increasing the loop current.

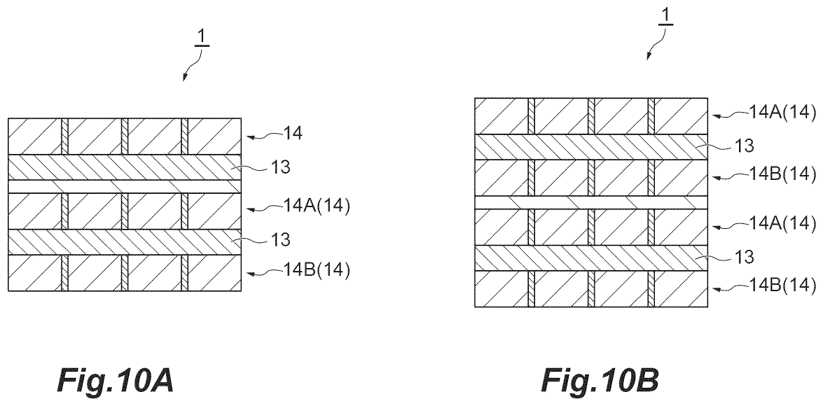

In addition, as illustrated in FIGS. 9C, 10A, and 10B, a plurality of layers of conductor patterns 14 may be stacked. In this case, communication characteristics can be improved by increasing the loop current. As illustrated in FIG. 9C, a structure in which a conductor pattern 14 is provided on one surface of a base material 13 may be stacked in multiple layers. In addition, as illustrated in FIG. 10A, a structure in which the conductor pattern 14 is provided on one surface of the base material 13 and a structure in which the conductor patterns 14 (mesh patterns 14A and 14B) are provided on both surfaces of the base material 13 may be stacked in multiple layers. In addition, as illustrated in FIG. 10B, a structure in which conductor patterns 14 (mesh patterns 14A and 14B) are provided on both surfaces of the base material 13 may be stacked in multiple layers.

### Aspect 1

An antenna device including a mesh-shaped conductor pattern having a plurality of mesh portions, in which
the conductor pattern includes a plurality of first electroconductive lines extending in a first direction and a plurality of second electroconductive lines extending in a second direction intersecting the first direction,
an opening and a slit extending from the opening to an edge of the conductor pattern are formed in the conductor pattern as a region where the first electroconductive lines and the second electroconductive lines are not formed,
a width of the slit is smaller than a width of the opening, and
at least a part of the mesh portions arranged at an edge of the slit is opened to the slit.

### Aspect 2

The antenna device according to Aspect 1, in which the mesh portions arranged at an edge of the opening are open to the opening.

### Aspect 3

The antenna device according to Aspect 1, in which a conductor portion having a wider line width than the first electroconductive lines and the second electroconductive lines is disposed along an edge of the opening.

### Aspect 4

The antenna device according to any one of Aspects 1 to 3, further including:
a base material, in which
the conductor pattern includes a first mesh pattern provided on a first main surface of the base material and a second mesh pattern provided on a second main surface of the base material, and
at least a part of the electroconductive lines of the first mesh pattern overlaps the electroconductive lines of the second mesh pattern when viewed from a thickness direction of the base material.

### Aspect 5

The antenna device according to any one of Aspects 1 to 4, in which a plurality of layers of the conductor patterns is stacked.

### Aspect 6

The antenna device according to Aspect 2, in which a pair of first ends of the first electroconductive lines facing each other in the first direction through the opening and a pair of second ends of the second electroconductive lines facing each other in the second direction through the opening have a tapered shape expanding from one side to another side in the thickness direction.

### Aspect 7

The antenna device according to any one of Aspects 1 to 6, in which the first electroconductive lines and the second electroconductive lines have a line thickness larger than a line width.

### Aspect 8

The antenna device according to any one of Aspects 1 to 7, in which the mesh portions are provided with resin, and a space is formed in the opening.

### Aspect 9

The antenna device according to any one of Aspects 1 to 8, in which one of the first electroconductive lines and the second electroconductive lines is substantially parallel to an extending direction of the slit, and another of the first electroconductive line and the second electroconductive line is substantially orthogonal to the extending direction.

### Aspect 10

The antenna device according to any one of Aspects 1 to 9, in which a width of the slit is larger than a pitch of the mesh portions.

### Aspect 11

An IC card including:
the antenna device according to any one of Aspects 1 to 10; and
an IC module disposed in the opening.

### REFERENCE SIGNS LIST

1 Antenna device
13 Base material
14 Conductor pattern
14A First mesh pattern
14B Second mesh pattern
16 Resin layer (resin)
17 Mesh portion
20 Opening
21 Slit
30 First electroconductive line
31 Second electroconductive line
50 IC module
100 IC card

What is claimed is:

1. An antenna device comprising a mesh-shaped conductor pattern having a plurality of mesh portions, wherein
the conductor pattern includes a plurality of first electroconductive lines extending in a first direction and a plurality of second electroconductive lines extending in a second direction intersecting the first direction, and
the conductor pattern includes an opening and a slit extending from the opening to an edge of the conductor pattern as a region where the first electroconductive lines and the second electroconductive lines are not formed,
a width of the slit is smaller than a width of the opening, and
at least a part of the mesh portions arranged at an edge of the slit is opened to the slit.

2. The antenna device according to claim 1, wherein the mesh portions arranged at an edge of the opening are open to the opening.

3. The antenna device according to claim 1, wherein a conductor portion having a wider line width than the first electroconductive lines and the second electroconductive lines is disposed along an edge of the opening.

4. The antenna device according to claim 1, further comprising a base material, wherein
the conductor pattern includes a first mesh pattern provided on a first main surface of the base material and a second mesh pattern provided on a second main surface of the base material, and
at least a part of the electroconductive lines of the first mesh pattern overlaps the electroconductive lines of the second mesh pattern when viewed from a thickness direction of the base material.

5. The antenna device according to claim 1, wherein a plurality of layers of the conductor patterns is stacked.

6. The antenna device according to claim 2, wherein a pair of first ends of the first electroconductive lines facing each other in the first direction through the opening and a pair of second ends of the second electroconductive lines facing each other in the second direction through the opening have a tapered shape expanding from one side to another side in the thickness direction.

7. The antenna device according to claim 1, wherein the first electroconductive lines and the second electroconductive lines have a line thickness larger than a line width.

8. The antenna device according to claim 1, wherein the mesh portions are provided with resin, and a space is formed in the opening.

9. The antenna device according to claim 1, wherein one of the first electroconductive lines and the second electroconductive lines is substantially parallel to an extending direction of the slit, and another of the first electroconductive line and the second electroconductive line is substantially orthogonal to the extending direction.

10. The antenna device according to claim 1, wherein a width of the slit is larger than a pitch of the mesh portions.

11. An IC card comprising:
the antenna device according to claim 1; and
an IC module disposed in the opening.
